(19) United States
(12) Patent Application Publication
(10) Pub. No.: US 2020/0285787 A1
(43) Pub. Date: Sep. 10, 2020

(54) VIBRATION REDUCTION OPTIMIZATION METHOD FOR HOST SYSTEM OF TUNNEL BORING MACHINE

(71) Applicant: Dalian University of Technology, Dalian City (CN)

(72) Inventors: Junzhou HUO, Dalian City (CN); Zhaohui XU, Dalian City (CN); Zhange ZHANG, Dalian City (CN); Debin SUN, Dalian City (CN); Zhichao MENG, Dalian City (CN)

(21) Appl. No.: 16/469,112

(22) PCT Filed: Dec. 14, 2018
(86) PCT No.: PCT/CN2018/121013

§ 371 Date: Jun. 12, 2019

(30) Foreign Application Priority Data
Oct. 31, 2018 (CN) 201811281683. 7
Nov. 1, 2018 (CN) 201811290783.6
Nov. 1, 2018 (CN) 201811295375.X
Nov. 5, 2018 (CN) 201811305468.6
Nov. 8, 2018 (CN) 201811325115.2
Nov. 9, 2018 (CN) 201811329963.0

(51) Int. Cl. G06F 30/20; E21D 9/10; G06F 30/17

(52) U.S. Cl. CPC G06F 30/20; G06F 2111/10; G06F 30/17; E21D 9/106

(57) ABSTRACT

A vibration reduction optimization method for host system of a tunnel boring machine to reduce the vibration of the host and prevent fatigue damage at the critical weak position of the TBM host system. Vibration reduction optimization of the TBM host system is achieved by using a damping alloy material to replace the cutterhead system's material and the connecting flange's material and adding a magnetorheological damper at the support system and the propulsion system. This prevents sudden incidents in the TBM host system and ensures that the TBM works safely and reliably.

### TECHNICAL FIELD

The present invention relates to vibration reduction optimization method for host system of a tunnel boring machine (TBM), and belongs to the technical field of vibration reduction design of the TBM.

### BACKGROUND TECHNIQUE

Tunnel boring machine (TBM) is a factory-built assembly line tunnel construction equipment integrating machine, electricity, liquid, light and gas systems. It has the advantages of fast tunneling speed and high comprehensive efficiency. It is widely used in tunnel projects such as railways, hydropower, transportation, and mines. Due to the complex TBM tunneling environment and the multi-point impact rock breaking of the TBM cutter, the cutter will generate strong impact loads during rock cutting. This will cause the TBM host to vibrate violently, eventually causing wear and even breakage in some key parts of the TBM. Therefore, how to achieve the vibration reduction optimization of the host system is particularly important. Therefore, the vibration reduction optimization of the host system is particularly important.

The TBM host system (As shown in FIG. 1) is mainly composed of a cutterhead system, a support system, a propulsion system and a main beam. Severe load conditions cause severe vibration of the TBM host system, which in turn causes failure of the host system and affects the normal operation of the TBM. In order to ensure the safe and reliable operation of the TBM and reduce the occurrence of faults, it is necessary to reduce the severe vibration during the tunneling of the TBM host. Establishing a set of vibration reduction optimization method for TBM host system can not only reduce the incidence of faults and the number of repairs by construction personnel, but also ensure the safe and reliable operation of TBM.

Because the tunneling environment of TBM is very bad, although scholars have done some research on the vibration reduction optimization of TBM, there is no complete solution for the vibration reduction optimization of TBM host system. Because the structure of the TBM host system is complex and there are many coupling factors to be considered, although some scholars have done some theoretical research to improve the vibration reduction, there are many problems, such as serious model simplification, incomplete analysis, and poor engineering applicability. Such problems have made the research have certain limitations.

Based on the above condition, the present invention adopts the material replacement and reasonable arrangement of the magnetorheological damper (As shown in FIG. 2) to optimize the vibration reduction design of the TBM host system. For the vibration reduction of the cutterhead system, the material replacement model of the cutterhead's stiffened plate (As shown in FIG. 3) and the damping material replacement model of the wedge blocks of TBM cutter-holder connection structure (As shown in FIG. 4) are proposed. For the vibration reduction of the support system and propulsion system, the corresponding addition schemes of the magnetorheological damper are proposed. For the vibration reduction of connecting flanges, a material replacement method for flanges and connecting bolts is proposed. By making the above scheme, a set of vibration reduction optimization method for TBM host system is proposed.

### SUMMARY OF THE INVENTION

The object of the present invention is to provide a complete vibration reduction optimization method for a TBM host system.

### Technical Scheme of Invention

The vibration reduction optimization method for the host system of tunnel boring machine is as follows:

The vibration reduction optimization method for the host system of tunnel boring machine includes the damping alloys for material replacement, the magnetorheological damper, the material replacement model of the cutterhead stiffened plate, the damping material replacement model of wedge blocks of TBM's cutter-holder connection structure, the addition schemes of the magnetorheological damper at support cylinder and propulsion cylinder, and the material replacement schemes of flanges and connecting bolts. The material replacement of cutterhead system and connecting flange and adding magnetorheological dampers to support cylinder and propulsion cylinder to realize vibration reduction optimization design of TBM host system. The specific system includes the following aspects: the material optimal replacement model of cutterhead system, the addition schemes of magnetorheological damper at support system and propulsion system, the material replacement scheme of connecting flange.

I. The Material Optimal Replacement Model of Cutterhead System

Model 1, the Material Replacement Model of the Cutterhead's Stiffened Plates

The purpose of this model is to propose an optimization scheme for damping alloy replacement of the cutterhead's stiffened plates, to realize the optimal replacement of the stiffener material and reduce the overall vibration of the cutterhead in the transmission process. Furthermore, the vibration of TBM is reduced, the emergence of TBM accidents is prevented, and the safe and reliable operation of TBM is ensured. The partial replacement material method is used to minimize the vibration of the stiffened plates and reduce the vibration of the TBM. Furthermore, an optimized layout model of damping alloy replacement stiffened plates material is proposed (As shown in FIG. 5). The formula of the optimized layout model is as follows: y=

$$α ( {ae}^{bx} + cos ( cx + d ) + \frac{{ex}^{2} + f}{x + g} )$$

In the formula: a and b are the index coefficient, their ranges of values are −6.1˜−4.3 and 0.11˜0.150, respectively, the above parameters decrease with the increase of the number of regions.

c and d are the cosine coefficient, their ranges of values are 0.7-0.93 and 1.3-2.5, respectively, the above parameters increase with the increase of the number of regions.

e, f and g are the main item coefficient, their ranges of values are 2.6˜5.2, −4.4˜−4.1 and −1.2˜-0.9, respectively, the above parameters increase with the increase of the number of regions.

α is the coefficient of regional division, 1.1-1.72, the above parameters increase with the increase of the number of regions.

x and y are the area number and the replacement area number, respectively, their ranges of values are 1-n.

Description of the model: The optimized layout model takes the area where the cutterhead is located as the divided area, with the center of the cutterhead as the center O, and the four center cutters around the center O are symmetrically distributed horizontally and vertically, forming the first ellipse with O as the center. The normal cutters arranged on the long and short axes of the first circle ellipse forms a plurality of concentric ellipses. The outermost circle ellipse and the edge ribs are the last layer (the small circle in FIG. 5 is the cutter position). Divide the area according to θ° equally, with the direction of the transverse center hob as the center line, rotate up and down (θ/2°), and define it as No. 1 area number (as shown in the shaded part of FIG. 5). We continue to number in a counterclockwise direction, sequentially numbering the area from the inside out, until the number n ends the number. If the stiffened plate is between the replacement area and non-replacement area, a hybrid replacement method is used, in which one part is replaced by a damping alloy and the other part is not replaced. When the last calculated replacement area number exceeds the number area, it can be discarded.

Model 2, the material replacement model for wedge blocks of TBM's cutter-holder connection structure

This model replaces the material of the wedge blocks of cutter-holder connection structure in the severe vibration area of the cutterhead with a damping alloy to reduce the vibration caused by the cutter. We replaced some of the material of the wedge block with a damping alloy to achieve the purpose of vibration reduction. The wedge block damping material replacement model is shown in FIG. 6. The formula of the specific material optimization model is as follows:

$$y = {δ [ {ax}^{2} + {be}^{- {( \frac{x - {R}_{1}}{{R}_{2}} )}^{2}} + {c ( sin ( x - d ) )}^{2} ]}^{ϕ}$$

In the formula: δ is the division angle coefficient, its range of value is 0.95-1.12, the smaller the unit angle value divided in the circumferential direction of the cutterhead, the smaller the value is;

φ is the structural coefficient of cutterhead, its range of value is 0.91-1.04, the more the cutterhead body is divided into blocks, the bigger its value is.

R₁ and R₂ are the diameter coefficients of the normal cutter area and the sgauge cutter area, respectively, their ranges of values are 2.603-3.535 and 0.346-1.705, respectively, the bigger the circumference diameter is, the bigger their values are.

a, b, c and d are the binomial coefficient, index coefficient, sinusoidal coefficient and initial phase coefficient, respectively, their ranges of values are 0.415-0.487, 2.92-6.99, 3.209-8.063 and 3.224-3.649, respectively, the above coefficients increase as the unit angle value divided in the circumferential direction of the cutterhead decreases.

x and y are the area number and the replacement area number, respectively, and their ranges of values are 1-n.

Description of the model: This model takes the center of the cutterhead as the center of the circle. The maximum distance between the center cutter and the center of the cutterhead and the minimum distance between the gauge cutter and the center of the cutterhead are taken as the radius to make the circle respectively. The cutterhead is divided into three regions in the radial direction, from the inside to the outside, respectively, a center cutter region 6a, a normal cutter region 6b and a gauge cutter region 6c. Take the horizontal line passing through the center of the cutterhead as the first sheet. Based on the first sheet, according to a certain angle value (this model takes 30° as an example), the cutterhead is equally divided into several areas in the circumferential direction, and write the serial number x (x=1, 2, 3, . . . , n) of the cutter area in the clockwise direction from the inside to the outside. In the normal cutter region 6b, starting from the left side, the number of the area above the first sheet is recorded as 1, after the normal cutter region 6b is written, the gauge cutter region 6c is written in the same manner. Bring the already written serial number into the material optimization model and solve the value of f(x). If the value is a non-integer, take the integer part. The value obtained is the area number (the shaded area in the figure) where the wedge block material needs to be replaced with a damping alloy. Until f(x)≥x stops taking in, the result is all the areas that need to be replaced.

II. The Addition Scheme of Magnetorheological Damper at Support System and Propulsion System

According to the operability of the actual space, a magnetorheological damper is added near the support cylinder. The newly added magnetorheological damper includes magnetorheological damper 2 on the right, Magnetorheological damper 5 on the upper right side, magnetorheological damper 7 on the lower right, magnetorheological damper 10 on the lower left, magnetorheological damper 12 on the upper left, magnetorheological damper 15 on the left, magnetorheological damper 18 on the upper left and magnetorheological damper 21 on the upper right. The diagram of the scheme is shown in FIGS. 7a-7c. The specific adding scheme is as follows:

Located between the upper shield 1 and the main drive 16, there are a left upper cylinder 14 and a right upper cylinder 3, respectively. Adding a magnetorheological damper 15 in the range of 90-600 mm from the left upper cylinder 14 in the direction of the host tunneling direction. Adding a magnetorheological damper 2 in the range of 90-600 mm from the right upper cylinder 3 in the direction of the host tunneling direction. The angle between the axis of the magnetorheological damper and the vertical direction of the host is 0°˜60°, and its function is mainly to reduce the longitudinal vibration of the host system. There is a left upper cylinder 19 between the upper left side shield 13 and the main drive 16. A magnetorheological damper 18 is added within a range of 0-500 mm from the left side of the left upper cylinder 19, a magnetorheological damper 12 is added within a range of 0-400 mm from the right side of the upper left cylinder 19. There is a right upper cylinder 20 between the upper right shield 4 and the main drive 16. A magnetorheological damper 5 is added within a range of 0-400 mm from the left side of the upper right cylinder 20, A magnetorheological damper 21 is added within a range of 0-500 mm from the right side of the upper right cylinder 20. The installation axes of the two sets of magnetorheological dampers are parallel to the axis of the supporting cylinder, and their functions are mainly to reduce the longitudinal vibration and the lateral vibration of the main system respectively. There is a left lower cylinder 9 between the left shield 11 and the main drive 16. Adding a magnetorheological damper 10 in the range of 300-600 mm from the left lower cylinder 9 in the direction of the host tunneling direction. There is a right lower cylinder 8 between the right shield 6 and the main drive 16. Adding a magnetorheological damper 7 in the range of 300-600 mm from the right lower cylinder 8 in the direction of the host tunneling direction. The angle between the installation axis of the magnetorheological damper and the vertical direction of the host is −10°˜-90°, and its function is mainly to reduce the longitudinal vibration of the host system and the lateral vibration of the host system to some extent. In addition, magnetorheological dampers are added to the positions of the propulsion cylinders on both sides of the TBM, as shown in FIG. 8.

III. The Material Replacement Scheme of Connecting Flange

In order to reduce the vibration of the TBM connection position, we use a polymer sandwich damping vibration reduction steel plate and a partial replacement method of the bolt material to achieve the purpose of vibration reduction. The specific scheme is as follows:

For the damping optimization of the TBM connecting flange, we mainly use the polymer sandwich damping vibration reduction steel plate (As shown in FIGS. 9a-9b). The polymer sandwich damping vibration reduction steel plate is divided into three layers, the upper layer and the lower layer are steel plates, and the inner layer is a damping material (the circular connection flange of the cutterhead is taken as an example). By constructing the dynamic model of the tunnel boring machine, the model results are analyzed and compared, and the thickness t1 of the damping material and the thickness t2 of the steel plate are determined. For the replacement of bolt material, in the flange bolt structure, material replacement is performed at intervals of one group.

The present invention has the beneficial effects that: the invention proposes a vibration reduction optimization method for a host system of a tunnel boring machine to reduce the vibration of the host system and prevent fatigue damage at the critical weak position of the TBM host system. Vibration reduction optimization of the TBM host system is achieved by using a damping alloy material to replace the cutterhead system's material and the connecting flange's material and adding a magnetorheological damper at the support system and the propulsion system. This also reduces the difficulty of TBM structural optimization, prevents the occurrence of sudden accidents of the TBM host system, and ensures that the TBM works safely and reliably.

### DESCRIPTION OF DRAWINGS

FIG. 1 is an overall diagram of TBM;

FIG. 2 is the magnetorheological damper;

FIG. 3 is the stiffened plates of cutterhead;

FIG. 4 is TBM's cutter-holder connection structure;

FIG. 5 is the material replacement model of the cutterhead's stiffened plates;

FIG. 6 is the material replacement model for wedge blocks of TBM's cutter-holder connection structure;

FIGS. 7a-7c are the addition scheme of magnetorheological damper for support system;

FIG. 8 is the addition scheme of magnetorheological damper for propulsion system;

FIGS. 9a-9b are the polymer sandwich damping vibration reduction steel plate.

In the figures: la: the cutterhead system; 1b: the support system; 1c: the propulsion system; 1d: the main beam; 2a: the ring; 2b: the piston rod; 2c: the cylinder body; 2d: the piston; 2e: the magnetorheological fluid; 2f: the coil; 2g: the damping channel coil; 2h: the piston; 2i: the coil lead; 4a: the upper wedge block; 4b: the lower wedge block; 6a: the area of the center cutter; 6b: the area of the normal cutter; 6c: the area of the gauge cutter; 7a: the main drive and shield system structure; 7b: the add position of the left magnetorheological damper; 7c: the add position of the right magnetorheological damper; 8a: the propulsion cylinder; 8b: the magnetorheological damper;

1: the upper shield; 2: the magnetorheological damper on the right; 3: the right upper cylinder; 4: the right upper shield; 5: the right upper magnetorheological damper; 6: the right shield; 7 the right lower magnetorheological damper; 8: the right lower cylinder; 9: the left lower cylinder; 10: the left lower magnetorheological damper; 11: the left shield; 12: the left upper magnetorheological damper; 13: the left upper shield; 14: the left upper cylinder; 15: the magnetorheological damper on the left; 16: the main drive; 17: the driving motor; 18: the upper left upper magnetorheological damper; 19: the left upper cylinder; 20: the right upper cylinder; 21: the right upper magnetorheological damper.

### DETAILED DESCRIPTION

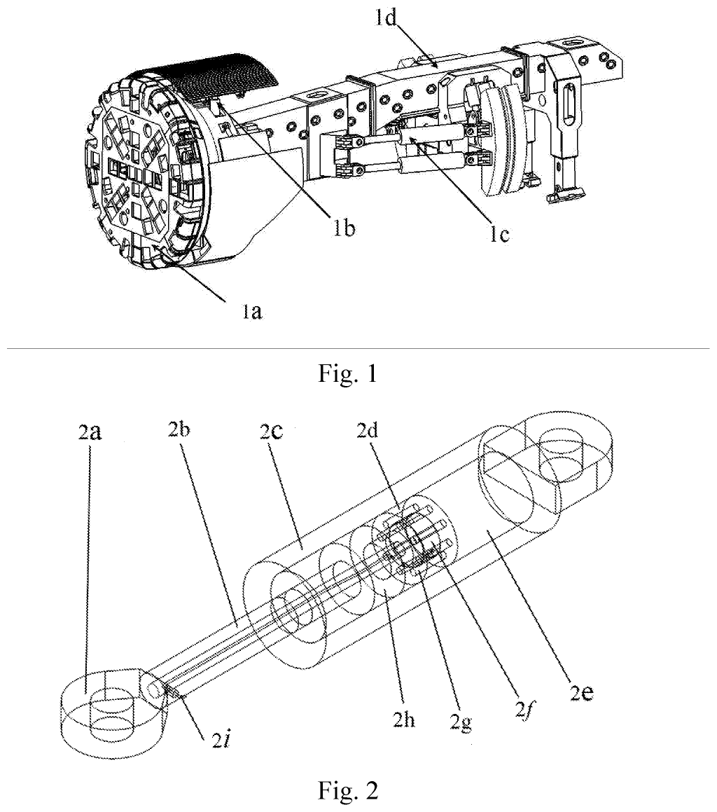

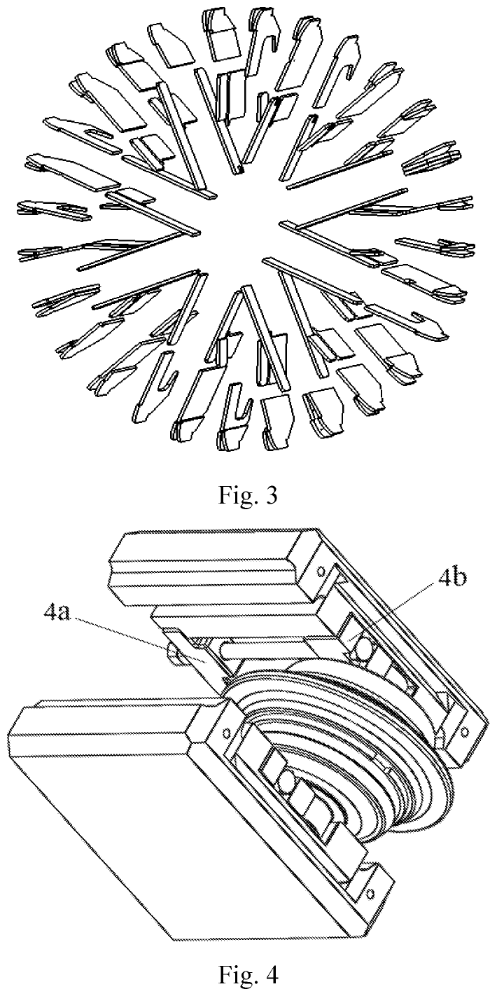

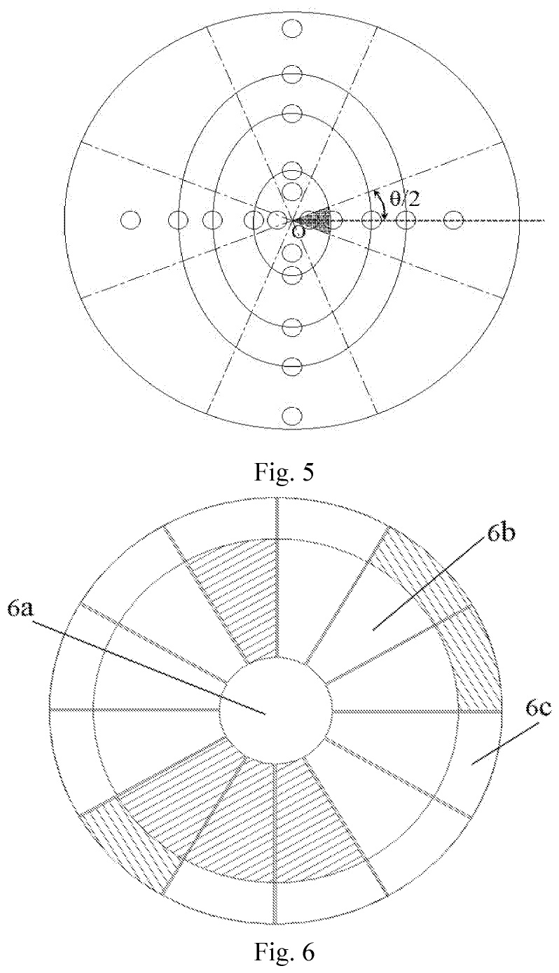

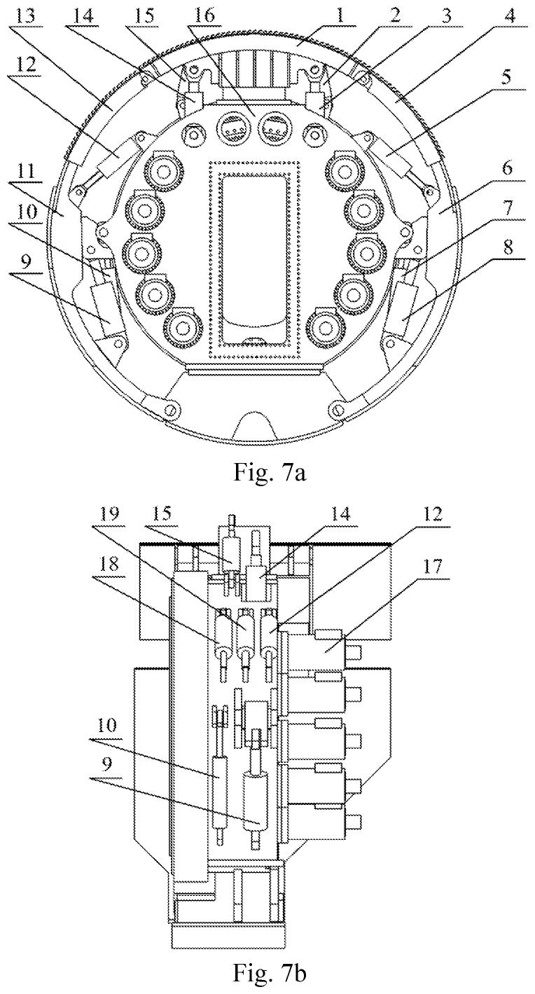

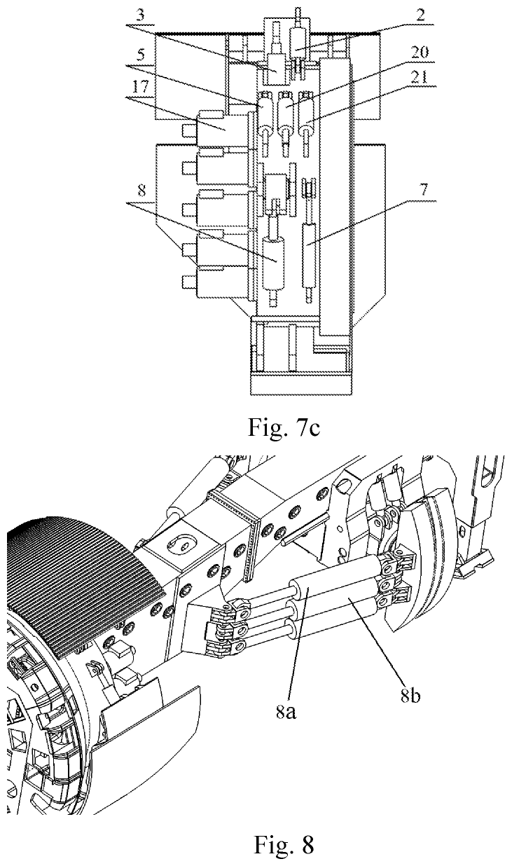

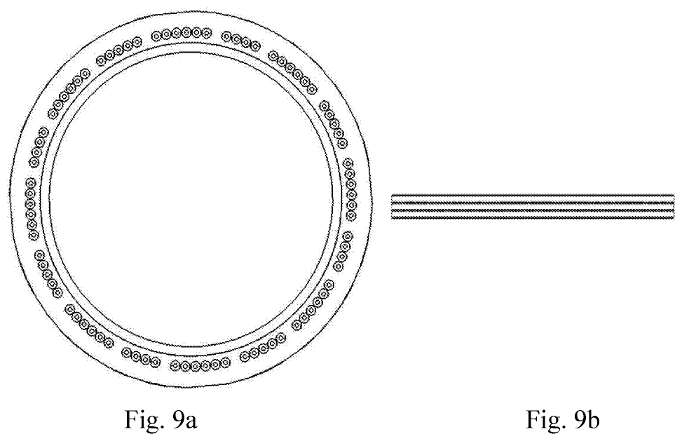

The specific embodiments of the present invention are described in detail below with reference to the accompanying drawings and technical solutions. FIG. 1 is a schematic diagram of a TBM host system of a project, including the main components such as the cutterhead system, the support system, the propulsion system and the main beam. During the work of TBM, the cutter has the characteristics of multi-point impact rock breaking. When the cutter cuts the rock, a strong impact load will be generated, which will cause the TBM to vibrate violently, eventually causing wear and even breakage of some key parts of the TBM.

For the cutterhead system, the material replacement of the cutterhead's stiffened plates and the wedge blocks in the cutter-holder connection structure achieves the purpose of vibration reduction optimization, and the material replacement model of the cutterhead's stiffened plates and the material replacement model for wedge blocks of TBM's cutter-holder connection structure are proposed. The material replacement of the cutterhead's stiffened plates and the wedge blocks is completed to achieve vibration reduction of the cutterhead system. For the support system and the propulsion system, the magnetorheological damper addition scheme of the support system and the propulsion system is used to add the corresponding magnetorheological damper to realize the vibration reduction optimization of the support system and the propulsion system. For the connection flange between the components, the polymer sandwich damping vibration reduction steel plate and the partial replacement method of the bolt material are used to optimize the vibration reduction at the joint. Through the above measures, the vibration reduction optimization of the cutterhead system, the support system, the propulsion system and the connection position can be achieved. The overall vibration reduction requirements of the TBM host system are realized from the corresponding vibration reduction measures of the tunnelling site, the support site, the propulsion site and the connection site.

### INDUSTRIAL APPLICABILITY

The invention proposes a vibration reduction optimization method for a host system of a tunnel boring machine to reduce the vibration of the host and prevent fatigue damage at the critical weak position of the TBM's host system. Damping alloy material is used to replace the material of the cutterhead system and the connecting flange, and a magnetorheological damper is added at the supporting system and the propulsion system to realize the vibration reduction optimization of the TBM host system, prevent the sudden failure of the TBM cutterhead system, and ensure that the TBM works safely and reliably.

1. A vibration reduction optimization method for host system of tunnel boring machine, wherein mainly comprises the material optimal replacement model for cutterhead system, addition scheme of magnetorheological damper for support system and propulsion system, material replacement scheme for connecting flange, and the specific steps are as follows:
I. the material optimal replacement model of cutterhead system
model 1, the material replacement model of the cutterhead's stiffened plates;
the partial replacement material method is used to minimize the vibration of the stiffened plates and reduce the vibration of the TBM; furthermore, an optimized layout model of damping alloy replacement stiffened plates material is proposed; the formula of the optimized layout model is as follows:
$$y = α ( {ae}^{bx} + cos ( cx + d ) + \frac{{ex}^{2} + f}{x + g} ) ;$$
in the formula: a and b are the index coefficient, their ranges of values are −6.1-4.3 and 0.11-0.150, respectively, the above parameters decrease with the increase of the number of regions;
c and d are the cosine coefficient, their ranges of values are 0.7-0.93 and 1.3-2.5, respectively, the above parameters increase with the increase of the number of regions;
e, f and g are the main item coefficient, their ranges of values are 2.6-5.2, −4.4-−4.1 and −1.2-−0.9, respectively, the above parameters increase with the increase of the number of regions;
α is the coefficient of regional division, 1.1-1.72, the above parameters increase with the increase of the number of regions;
x and y are the area number and the replacement area number, respectively, their ranges of values are 1-n;
description of the model: The optimized layout model takes the area where the cutterhead is located as the divided area, with the center of the cutterhead as the center O, and the four center cutters around the center O are symmetrically distributed horizontally and vertically, forming the first ellipse with O as the center; the normal cutters arranged on the long and short axes of the first circle ellipse forms a plurality of concentric ellipses; the outermost circle ellipse and the edge ribs are the last layer; divide the area according to θ° equally, with the direction of the transverse center hob as the center line, rotate up and down (θ/2°), and define it as No. 1 area number; we continue to number in a counterclockwise direction, sequentially numbering the area from the inside out, until the number n ends the number; if the stiffened plate is between the replacement area and non-replacement area, a hybrid replacement method is used, in which one part is replaced by a damping alloy and the other part is not replaced; when the last calculated replacement area number exceeds the number area, it can be discarded;
model 2, the material replacement model for wedge blocks of TBM's cutter-holder connection structure;
this model replaces the material of the wedge blocks of cutter-holder connection structure in the severe vibration area of the cutterhead with a damping alloy to reduce the vibration caused by the cutter; we replaced some of the material of the wedge block with a damping alloy to achieve the purpose of vibration reduction; the formula of the specific material optimization model is as follows:
$$y = {δ [ {ax}^{2} + {be}^{- {( \frac{x - {R}_{1}}{{R}_{2}} )}^{2}} + {c ( sin ( x - d ) )}^{2} ]}^{ϕ} ;$$
in the formula: δ is the division angle coefficient, its range of value is 0.95-1.12, the smaller the unit angle value divided in the circumferential direction of the cutterhead, the smaller the value is;
φ is the structural coefficient of cutterhead, its range of value is 0.91-1.04, the more the cutterhead body is divided into blocks, the bigger its value is;
R₁ and R₂ are the diameter coefficients of the normal cutter area and the sgauge cutter area, respectively, their ranges of values are 2.603-3.535 and 0.346-1.705, respectively, the bigger the circumference diameter is, the bigger their values are;
a, b, c and d are the binomial coefficient, index coefficient, sinusoidal coefficient and initial phase coefficient, respectively, their ranges of values are 0.415-0.487, 2.92-6.99, 3.209-8.063 and 3.224-3.649, respectively, the above coefficients increase as the unit angle value divided in the circumferential direction of the cutterhead decreases;
x and y are the area number and the replacement area number, respectively, and their ranges of values are 1-n;
description of the model: This model takes the center of the cutterhead as the center of the circle; the maximum distance between the center cutter and the center of the cutterhead and the minimum distance between the gauge cutter and the center of the cutterhead are taken as the radius to make the circle respectively; the cutterhead is divided into three regions in the radial direction, from the inside to the outside, respectively, a center cutter region, a normal cutter region and a gauge cutter region; take the horizontal line passing through the center of the cutterhead as the first sheet; based on the first sheet, according to a certain angle value, the cutterhead is equally divided into several areas in the circumferential direction, and write the serial number x of the cutter area in the clockwise direction from the inside to the outside, x=1, 2, 3, . . . , n; in the normal cutter region, starting from the left side, the number of the area above the first sheet is recorded as 1, after the normal cutter region is written, the gauge cutter region is written in the same manner; bring the already written serial number into the material optimization model and solve the value of f(x); if the value is a non-integer, take the integer part; the value obtained is the area number where the wedge block material needs to be replaced with a damping alloy; until f(x)≥x stops taking in, the result is all the areas that need to be replaced;
II. the addition scheme of magnetorheological damper at support system and propulsion system;
according to the operability of the actual space, a magnetorheological damper is added near the support cylinder; the newly added magnetorheological damper includes magnetorheological damper 2 on the right, magnetorheological damper 5 on the upper right side, magnetorheological damper 7 on the lower right, magnetorheological damper 10 on the lower left, magnetorheological damper 12 on the upper left, magnetorheological damper 15 on the left, magnetorheological damper 18 on the upper left and magnetorheological damper 21 on the upper right; the specific adding scheme is as follows:
located between the upper shield 1 and the main drive 16, there are a left upper cylinder 14 and a right upper cylinder 3, respectively; adding a magnetorheological damper 15 in the range of 90-600 mm from the left upper cylinder 14 in the direction of the host tunneling direction; adding a magnetorheological damper 2 in the range of 90-600 mm from the right upper cylinder 3 in the direction of the host tunneling direction; the angle between the axis of the magnetorheological damper and the vertical direction of the host is 0°˜60°, and its function is mainly to reduce the longitudinal vibration of the host system; there is a left upper cylinder 19 between the upper left side shield 13 and the main drive 16; a magnetorheological damper 18 is added within a range of 0-500 mm from the left side of the left upper cylinder 19, a magnetorheological damper 12 is added within a range of 0-400 mm from the right side of the upper left cylinder 19; there is a right upper cylinder 20 between the upper right shield 4 and the main drive 16; a magnetorheological damper 5 is added within a range of 0-400 mm from the left side of the upper right cylinder 20; a magnetorheological damper 21 is added within a range of 0-500 mm from the right side of the upper right cylinder 20; the installation axes of the two sets of magnetorheological dampers are parallel to the axis of the supporting cylinder, and their functions are mainly to reduce the longitudinal vibration and the lateral vibration of the main system respectively; there is a left lower cylinder 9 between the left shield 11 and the main drive 16; adding a magnetorheological damper 10 in the range of 300-600 mm from the left lower cylinder 9 in the direction of the host tunneling direction; there is a right lower cylinder 8 between the right shield 6 and the main drive 16; adding a magnetorheological damper 7 in the range of 300-600 mm from the right lower cylinder 8 in the direction of the host tunneling direction; the angle between the installation axis of the magnetorheological damper and the vertical direction of the host is −10°˜90°, and its function is mainly to reduce the longitudinal vibration of the host system and the lateral vibration of the host system to some extent; in addition, magnetorheological dampers are added to the positions of the propulsion cylinders on both sides of the TBM;
III. the material replacement scheme of connecting flange;
in order to reduce the vibration of the TBM connection position, we use a polymer sandwich damping vibration reduction steel plate and a partial replacement method of the bolt material to achieve the purpose of vibration reduction; the specific scheme is as follows:
for the damping optimization of the TBM connecting flange, we mainly use the polymer sandwich damping vibration reduction steel plate; the polymer sandwich damping vibration reduction steel plate is divided into three layers, the upper layer and the lower layer are steel plates, and the inner layer is a damping material; by constructing the dynamic model of the tunnel boring machine, the model results are analyzed and compared, and the thickness of the damping material and the thickness of the steel plate are determined; for the replacement of bolt material, in the flange bolt structure, material replacement is performed at intervals of one group.
